(19) United States
(12) Patent Application Publication
(10) Pub. No.: US 2023/0329305 A1
(43) Pub. Date: Oct. 19, 2023

(54) ZEIN-BASED FOOD FORMULATIONS

(71) Applicants: Purdue Research Foundation, West Lafayette, IN (US); Ohio State Innovation Foundation, Columbus, OH (US)

(72) Inventors: Bruce R. Hamaker, West Lafayette, IN (US); Oguz K. Ozturk, West Lafayette, IN (US); Osvaldo H. Campanella, Dublin, OH (US); Andres M. Salgado, Wooster, OH (US)

(73) Assignee: Purdue Research Foundation, West Lafayette, IN (US)

(21) Appl. No.: 18/136,587

(22) Filed: Apr. 19, 2023

Related U.S. Application Data
(60) Provisional application No. 63/332,528, filed on Apr. 19, 2022.

(51) Int. Cl. A23L 33/185; A23L 17/00; A23C 19/00; A23L 29/212; A23L 33/115

(52) U.S. Cl. CPC A23L 33/185; A23L 17/00; A23C 19/00; A23L 29/212; A23L 33/115

(57) ABSTRACT

A gluten-free, clean label, plant protein composition; a spreadable, gluten-free, clean label, plant protein composition; food products for human consumption comprising same; and methods of making.

### CROSS REFERENCE TO RELATED APPLICATION

This application claims priority to U.S. provisional patent application No. 63/332,528, which was filed on Apr. 19, 2022, and the content of which is hereby incorporated by reference in its entirety.

### STATEMENT OF GRANT SUPPORT

Research reported in this patent application was supported by the Foundation for Food and Agriculture Research under award no.: Grant ID: CA-PPP-0000000040.

### TECHNICAL FIELD

The present disclosure relates to plant-based protein formulations for manufacture of food analogues (e.g., analogues of meat and cheese) with desirable viscoelastic and cohesive properties.

### BACKGROUND

The commercial use of plant-based proteins (e.g., soy and pea) to make meat and cheese analogues has advanced significantly but the analogues are lacking in some important material properties, such as cohesiveness and viscoelasticity. Even though the industry has improved textural properties with wheat gluten or chemically modified viscoelastic hydrocolloid agents (e.g., methylcellulose), the analogues still do not yet match those of real meat and cheese products. At the same time, increasing consumer concerns regarding gluten intolerance and non-clean label ingredients have led the food industry to look to natural, alternative ingredients to provide the same properties.

In view of the above, it is an object of the present disclosure to provide alternative, non-gluten and clean label plant-based formulations with novel desirable properties, such as viscoelasticity and cohesiveness, that match the textural properties of meat and cheese plant-based protein analogues. This and other objects and advantages, as well as inventive features, will be apparent from the detailed description provided herein.

### SUMMARY

A gluten-free, clean label, plant protein composition is provided. The composition comprises (a) a plant protein, (b) a vegetable oil, (c) corn zein, (d) rice starch, and (e) an aqueous, alkaline, divalent cation. The plant protein can be the plant protein is pea protein, chickpea protein, cranberry protein, navy bean protein, pinto bean protein, adzuki protein, fava protein, lima protein, black bean protein, lentil protein, red kidney bean protein, split pea protein, mung bean protein, Great Northern bean protein, black-eyed pea protein, Anasazi protein, cannellini protein, pumpkin seed protein, soy protein, rice protein, sorghum protein, millet protein, or a combination thereof. The plant protein can be present in an amount of about 50% w/w of dry ingredients. The vegetable oil can be olive oil. The vegetable oil can be present in an amount of about 5% v/w of dry ingredients. The corn zein can be present in an amount of 25% w/w of dry ingredients. The rice starch can be present in an amount of 25% w/w of dry ingredients. The cation can be calcium hydroxide (Ca(OH)₂). The cation can be present in an amount from about 1% to about 7% w/v of the aqueous solution used to mix with the dry ingredients. The water containing the Ca(OH)₂ can be present in an amount from about 50% to about 125% v/w of the dry ingredients, depending on the plant protein used in the formulation.

A food product for human consumption is also provided, with the use of pea protein as the plant protein. The food product comprises an above-described composition. The food product can be a meat analogue (e.g., burger patties), in which case the food product can comprise about 7% w/v Ca(OH)₂ solution. The food product can be a hard cheese or canned fish analogue (e.g., Colby cheese, tuna fish), in which case the food product can comprise about 5% w/v Ca(OH)₂ solution. The food product can be a soft cheese or chicken analogue (e.g., mozzarella cheese, chicken nuggets), in which case the food product can comprise about 3% w/v Ca(OH)₂ solution. The food product can be a fish fillet analogue (e.g., tilapia fish), in which case the food product can comprise about 1% w/v Ca(OH)₂ solution.

Further provided is a spreadable, gluten-free, clean label ingredient, plant protein composition comprising (a) a plant protein, (b) a vegetable oil, (c) corn zein, and (d) water. The plant protein can be the plant protein is pea protein, chickpea protein, cranberry protein, navy bean protein, pinto bean protein, adzuki protein, fava protein, lima protein, black bean protein, lentil protein, red kidney bean protein, split pea protein, mung bean protein, Great Northern bean protein, black-eyed pea protein, Anasazi protein, cannellini protein, pumpkin seed protein, soy protein, rice protein, sorghum protein, millet protein, or a combination thereof. The plant protein can be present in an amount of about 80% w/w of dry ingredients. The vegetable oil can be olive oil. The vegetable oil can be present in an amount of about 8% v/w of dry ingredients. The corn zein can be present in an amount of about 20% w/w of dry ingredients. The water can be present in an amount of about 120% to about 300% v/w of the dry ingredients depending on the plant protein used in the formulation.

Still further provided is a food product for human consumption comprising the spreadable composition. The food product can be a nut butter analogue.

In view of the above, also provided is a method of making a gluten-free, clean label, plant protein composition. The method comprises (i) mixing a plant protein with a vegetable oil; (ii) adding corn zein to the mixture; (iii) mixing; (iv) adding rice starch; (v) mixing; (vi) adding an aqueous, alkaline, divalent cation; and (vii) mixing.

Also, in view of the above, a method of making a spreadable, gluten-free, clean label, plant protein composition is provided. The method comprises (i) mixing a plant protein with a vegetable oil; (ii) adding corn zein to the mixture; (iii) mixing; (iv) adding water; and (v) mixing.

### BRIEF DESCRIPTION OF FIGURES

FIG. 1A is a bar graph of sample vs. hardness (g).

FIG. 1B is a bar graph of sample vs. cohesion.

FIG. 1C is a bar graph of sample vs. springiness (%).

FIG. 1D is a bar graph of sample vs. resilience (%).

FIG. 1E is a bar graph of sample vs. chewiness.

FIG. 1F is a bar graph of sample vs. gumminess.

FIG. 2 shows the representative scanning electron microscopy (SEM) images.

FIG. 3 shows the representative confocal laser scanning microscopy (CLSM) images.

FIG. 4A shows a representative image of spreadable material with pea protein.

FIG. 4B shows a representative image of spreadable material with chickpea protein.

FIG. 4C shows a representative image of spreadable material with pumpkin seed protein.

FIG. 4D shows a representative image of spreadable material with combination thereof.

### DETAILED DESCRIPTION

The present disclosure is predicated, at least in part, on the discovery that plant-based formulations for food products, such as for human consumption, can be made with desirable viscoelastic and cohesive properties, improved over current products and in the absence of gluten and non-clean label ingredients. In view of the above, a gluten-free, clean label, plant protein composition is provided. The composition comprises (a) a plant protein, (b) a vegetable oil, (c) corn zein, (d) rice starch, and (e) an aqueous, alkaline, divalent cation.

The plant protein can be the plant protein is pea protein, chickpea protein, cranberry protein, navy bean protein, pinto bean protein, adzuki protein, fava protein, lima protein, black bean protein, lentil protein, red kidney bean protein, split pea protein, mung bean protein, Great Northern bean protein, black-eyed pea protein, Anasazi protein, cannellini protein, pumpkin seed protein, soy protein, rice protein, sorghum protein, millet protein, or a combination thereof. The plant protein can be present in an amount of about 50% w/w of dry ingredients.

The vegetable oil can be any suitable vegetable oil. An example is olive oil. The vegetable oil can be present in an amount of about 5% v/w of dry ingredients.

The corn zein can be present in an amount of 25% w/w of dry ingredients.

The rice starch can be present in an amount of 25% w/w of dry ingredients.

The cation can be calcium hydroxide (Ca(OH)₂). The cation can be present in an amount from about 1% to about 7% w/v of the aqueous solution.

The composition can comprise one of the plant proteins stated above, olive oil, corn zein, rice starch, and Ca(OH)₂. The composition can comprise the plant protein in an amount of about 50% w/w of dry ingredients, olive oil in an amount of about 5% v/w of dry ingredients, corn zein in an amount of about 25% w/w of dry ingredients, rice starch in an amount of about 25% w/w of dry ingredients, and Ca(OH)₂ in an amount of about 1% to about 7% w/v of the aqueous solution used to mix with the dry ingredients. The Ca(OH)₂ solution can be present in an amount from about 50% to about 125% v/w of dry ingredients depending on the plant protein used in the formulation. It can be 100% v/w of dry ingredients for formulations include pea protein, pumpkin seed protein, rice protein, or combination of all proteins (pea protein, chickpea protein, pumpkin seed protein, soy protein, rice protein), 50% v/w for formulation including chickpea protein, and 125% v/w for formulation including soy protein.

A food product for human consumption is also provided. The food product comprises an above-described composition. The food product can be a meat analogue (e.g., burger patties), in which case the food product can comprise about 7% w/v Ca(OH)₂ solution. The food product can be a hard cheese or a canned fish analogue (e.g., Colby cheese, tuna fish), in which case the food product can comprise about 5% w/v Ca(OH)₂ solution. The food product can be a soft cheese or chicken analogue (e.g., mozzarella cheese, chicken nuggets), in which case the food product can comprise about 3% w/v Ca(OH)₂ solution. The food product can be a fish fillet analogue (e.g., tilapia fish), in which case the food product can comprise about 1% w/v Ca(OH)₂ solution.

Further provided is a spreadable, gluten-free, clean label ingredient, plant protein composition comprising (a) a plant protein, (b) a vegetable oil, (c) corn zein, and (d) water.

The plant protein in the spreadable composition can be the plant protein is pea protein, chickpea protein, cranberry protein, navy bean protein, pinto bean protein, adzuki protein, fava protein, lima protein, black bean protein, lentil protein, red kidney bean protein, split pea protein, mung bean protein, Great Northern bean protein, black-eyed pea protein, Anasazi protein, cannellini protein, pumpkin seed protein, soy protein, rice protein, sorghum protein, millet protein, or a combination thereof. The plant protein can be present in an amount of about 80% w/w of dry ingredients.

The vegetable oil in the spreadable composition can be any suitable vegetable oil. An example is olive oil. The vegetable oil can be present in an amount of about 8% v/w of dry ingredients.

The corn zein in the spreadable composition can be present in an amount of about 20% w/w of dry ingredients.

The water in the spreadable composition can be present in an amount of about 120% to about 300% v/w of dry ingredients.

Still further provided is a food product for human consumption comprising the spreadable composition. Examples include nut butter analogues.

In view of the above, also provided is a method of making a gluten-free, clean label, plant protein composition. The method comprises (i) mixing a plant protein with a vegetable oil; (ii) adding corn zein to the mixture; (iii) mixing; (iv) adding rice starch; (v) mixing; (vi) adding an aqueous, alkaline, divalent cation; and (vii) mixing. The plant protein can be the plant protein is pea protein, chickpea protein, cranberry protein, navy bean protein, pinto bean protein, adzuki protein, fava protein, lima protein, black bean protein, lentil protein, red kidney bean protein, split pea protein, mung bean protein, Great Northern bean protein, black-eyed pea protein, Anasazi protein, cannellini protein, pumpkin seed protein, soy protein, rice protein, sorghum protein, millet protein, or a combination thereof. The plant protein can be present in an amount of about 50% w/w of dry ingredients. The vegetable oil can be olive oil. The vegetable oil can be present in an amount of about 5% v/w of dry ingredients. The corn zein can be present in an amount of 25% w/w of dry ingredients. The rice starch can be present in an amount of 25% w/w of dry ingredients. The cation can be Ca(OH)₂. The cation can be present in an amount from about 1% to about 7% w/v in an aqueous solution. Ca(OH)₂ solution can be present in an amount from about 50% to about 125% v/w of dry ingredients, depending on the plant protein used in the formulation. It can be 100% v/w of dry ingredients for formulations include pea protein, pumpkin seed protein, rice protein, or combination of all proteins (pea protein, chickpea protein, pumpkin seed protein, soy protein, rice protein), 50% v/w for formulation including chickpea protein, and 125% v/w for formulation including soy protein.

Also, in view of the above, a method of making a spreadable, gluten-free, clean label, plant protein composition is provided. The method comprises (a) mixing a plant protein with a vegetable oil; (b) adding corn zein to the mixture; (c) mixing; (d) adding water; and (e) mixing. The plant protein can be the plant protein is pea protein, chickpea protein, cranberry protein, navy bean protein, pinto bean protein, adzuki protein, fava protein, lima protein, black bean protein, lentil protein, red kidney bean protein, split pea protein, mung bean protein, Great Northern bean protein, black-eyed pea protein, Anasazi protein, cannellini protein, pumpkin seed protein, soy protein, rice protein, sorghum protein, millet protein, or a combination thereof.

The plant protein can be present in an amount of about 80% w/w of dry ingredients. The vegetable oil can be olive oil. The vegetable oil can be present in an amount of about 8% v/w of dry ingredients. The corn zein can be present in an amount of about 20% w/w of dry ingredients. The water can be present in an amount of about 120% to about 300% v/w of dry ingredients depending on the plant protein used in the formulation.

Any suitable method as known in the art can be used to mix the ingredients in the above methods. For example, the ingredients can be mixed vigorously using a mixer or mortar and pestle, such as for 2-3 minutes after the addition of an ingredient. Mixing can be carried out at room temperature.

### EXAMPLES

The following examples serve to illustrate the present disclosure. The examples are not intended to limit the scope of the claimed invention.

### Example 1

### Preparation of Plant Protein Formulations for Food (e.g., Meat and Cheese) Analogues

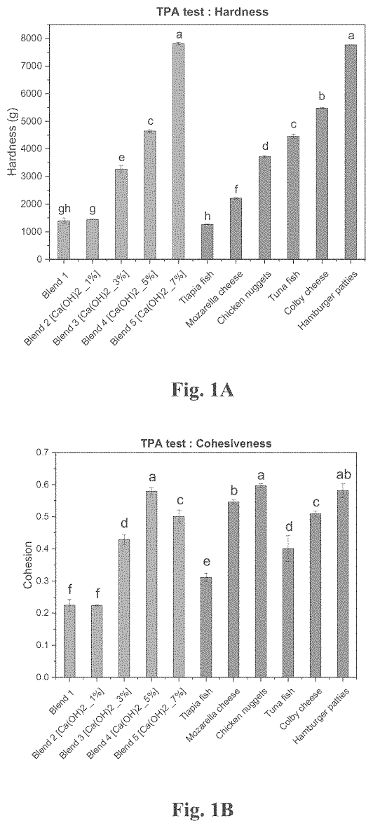

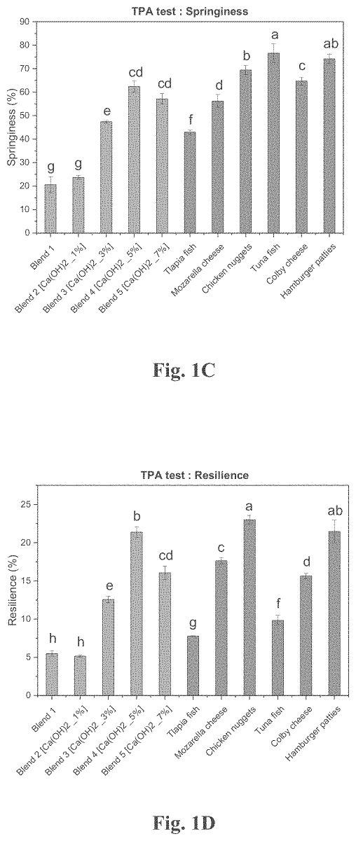

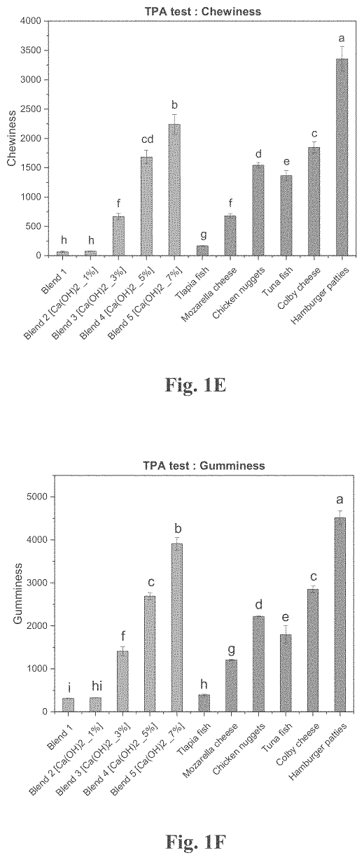

Corn zein and rice starch were combined with pea protein, chickpea protein, pumpkin seed protein, soy protein, rice protein, or a combination of all. The homogeneity and functionality of the blend was impacted by the order in which ingredients were combined. First, olive oil (5% (v/w) of dry matter) was mixed with a plant protein or combination of plant proteins (50% (w/w) of dry matter, equal amounts in the combination formulation). Then zein (25% (w/w) of dry matter), rice starch (25% (w/w) of dry matter), and Ca(OH)₂ solution (amounts are given for specific formulations, Table 1) were added to the oil/plant protein mixture in that order. A food-friendly (GRAS) ingredient (i.e., calcium hydroxide) was used with the plant-based protein blends to create food materials that match the textural properties of actual meat and cheese products (e.g., tilapia fish, mozzarella cheese, chicken nuggets, Colby cheese, tuna fish, and hamburger patties, in order from soft to firm) (FIGS. 1A-1F). For that, an aqueous calcium hydroxide solution (in a range of 1-7% (w/v)) was added, per the description above. After the addition of each ingredient, the blends were vigorously mixed (2-3 min after each addition) until a well-incorporated structure was obtained. Mixing of all ingredients was carried out at room temperature (˜22° C.). After the final mixing, the resulting dough-like blends were placed into plastic bags and put into a pre-heated water bath at 80° C. for 20 min.

TABLE 1
Water added to plant protein formulation

| | Ca(OH)₂ solution |
|---|---|
| Plant Protein Formulation | amount (% (v/w) |
| (80% (w/w) of dry matter) | of dry ingredients) |
| Pea Protein, Corn Zein and Rice Starch | 100% |
| Chickpea Protein, Corn Zein and Rice Starch | 50% |
| Pumpkin Seed Protein, Corn Zein and Rice Starch | 100% |
| Soy Protein, Corn Zein and Rice Starch | 125% |
| Rice Protein, Corn Zein and Rice Starch | 100% |
| Pea, Chickpea, Pumpkin Seed, Soy, Rice, Corn | 100% |
| Zein and Rice Starch | |

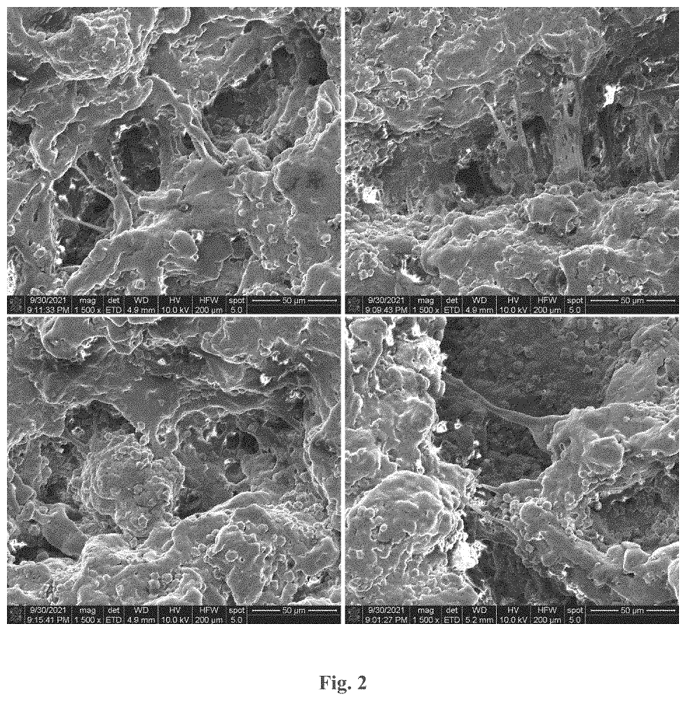

Textural properties of the formulation containing pea protein, corn zein and rice starch alone (Blend 1) or in combination with calcium hydroxide (Blend 2-5) as compared to tilapia fish, mozzarella cheese, chicken nuggets, tuna fish, Colby cheese, and hamburger patties are shown in FIGS. 1A-1F. FIG. 1A is a bar graph of sample vs. hardness (g). FIG. 1B is a bar graph of sample vs. cohesion. FIG. 1C is a bar graph of sample vs. springiness (%). FIG. 1D is a bar graph of sample vs. resilience (%). FIG. 1E is a bar graph of sample vs. chewiness. FIG. 1F is a bar graph of sample vs. gumminess. FIG. 2 presents representative scanning electron microscope images showing fibrils related to viscoelasticity of formulations. FIG. 3 presents representative confocal microscopy images showing viscoelastic zein fibrils that hold the structure together through a dispersed network. Scanning electron (FIG. 2) and confocal microscopy (FIG. 3) showed that zein forms cohesive viscoelastic fibers that hold the structure together through a dispersed network. The viscoelastic property is enhanced by rice starch, and an alkaline agent (e.g., a divalent cation, such as calcium hydroxide (Ca(OH)₂).

It was found that by changing the calcium hydroxide concentration used in the formulation, the textural properties (hardness, cohesiveness, springiness, resilience, gumminess, and chewiness) of plant-based protein formulations could be matched to those of commercial products. With a texture analyzer, chewing action in the mouth was mimicked by conducting a uniaxial compression test and the data on textural properties of pea protein-containing samples were compared to those of commercial cheese and meat products, including mozzarella and Colby cheeses, tuna and tilapia fish, chicken nuggets, and burger patties (FIG. 1A-F). All textural properties increased as calcium hydroxide concentration increased, except for a slight decrease in cohesiveness, springiness, and resilience when it increased from 5 to 7% w/v of the solution (green bars in FIG. 1). It was found that, specifically, hardness, chewiness, and gumminess of ingredient blends could be matched to those of tested commercial products by changing the calcium hydroxide concentration between 1 and 7% of the solution in the formulation (i.e., 1%—tilapia fish, 3%—chicken nugget and mozzarella cheese, 5%—tuna fish and Colby cheese, 7%—burger patties). Here, we show that calcium hydroxide, a food-friendly (GRAS) reagent, can be used to alter the textural properties of ingredient blends.

### Example 2

### Preparation of Spreadable Plant Protein Formulations for Food (e.g., Nut Butters) Analogues

Corn zein was combined with pea protein, chickpea protein, pumpkin seed protein, or a combination of all the foregoing. First, olive oil (8%, v/w of dry ingredients) was mixed into the above plant protein or plant protein blend (80%, w/w of dry ingredients). Then, zein (20%, w/w of dry ingredients) and water (amounts are given for specific formulations, Table 2) were added to oil/plant protein mixture in that order. After the addition of each ingredient, the blends were vigorously mixed until a well-incorporated structure was obtained (2-3 min after each addition). Mixing of all ingredients was carried out at room temperature (˜22° C.). The products were placed in a pre-heated water bath at 95° C. for 15 min to simulate cooking. After removal from the water bath, the materials were cooled at 4° C. for 2 h to produce the spreadable materials.

TABLE 2
Water added to spreadable plant protein formulation

| | Water amount |
|---|---|
| Plant Protein Formulation | (% (v/w) of dry ingredients) |
| Pea Protein and Corn Zein | 300% |
| Chickpea Protein and Corn Zein | 120% |
| Pumpkin Seed Protein and Corn | 180% |
| Zein | |
| Pea, Chickpea, Pumpkin Seed and | 160% |
| Corn Zein | |

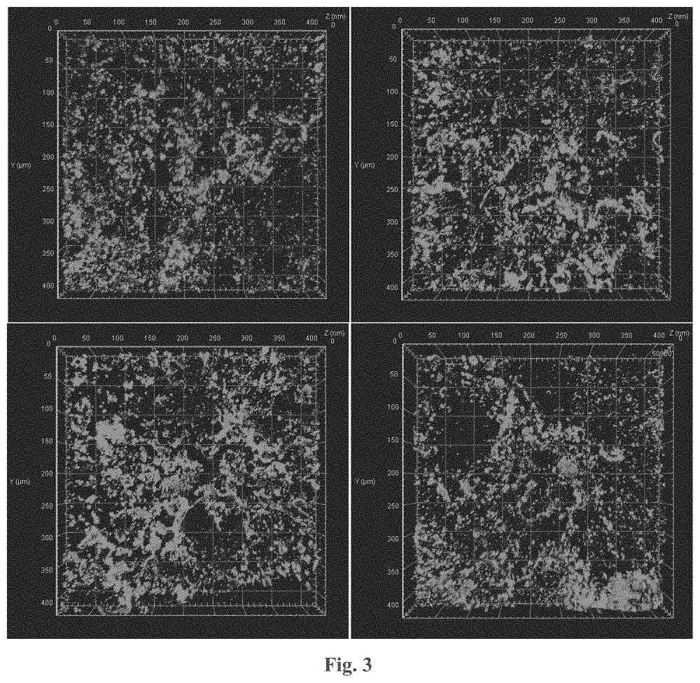

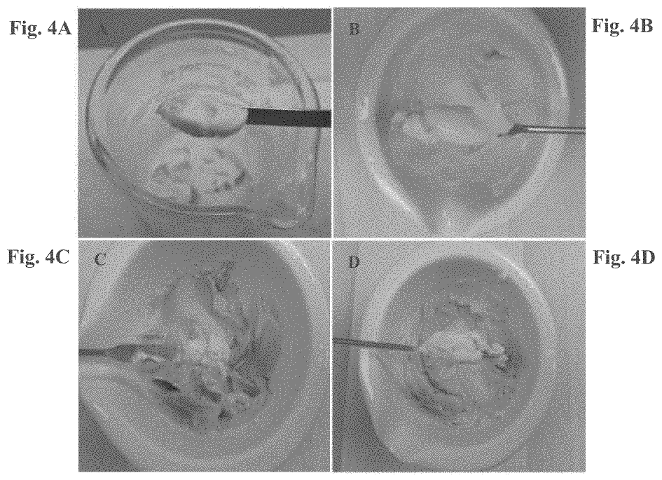

FIG. 4 presents images of formed spreadable materials with different plant proteins (A—pea protein, B—chickpea protein, C—pumpkin seed protein, and D—combination thereof). A fully plant-based protein spreadable material similar to nut butters (e.g., peanut butter) was obtained. The rheological properties and consistency of spreadable materials were similar to those of commercial products like peanut butter. Considering the allergenic problem of nuts to many consumers, this material would be a substitute to those nut spreads, and could have broader consumer appeal as a neutral carrier of flavors/nutrients.

All patents, patent application publications, journal articles, textbooks, and other publications mentioned in the specification are indicative of the level of skill of those in the art to which the disclosure pertains. All such publications are incorporated herein by reference to the same extent as if each individual publication were specifically and individually indicated to be incorporated by reference. In the event of inconsistent usages between this document and those documents so incorporated by reference, the usage in the incorporated reference should be considered supplementary to that of this document; for irreconcilable inconsistencies, the usage in this document controls.

The invention illustratively described herein may be suitably practiced in the absence of any element(s) or limitation(s), which is/are not specifically disclosed herein. Thus, for example, each instance herein of any of the terms “comprising,” “consisting essentially of,” and “consisting of” may be replaced with either of the other two terms. Likewise, the singular forms “a,” “an,” and “the” include plural references unless the context clearly dictates otherwise. Thus, for example, references to “the method” includes one or more methods and/or steps of the type, which are described herein and/or which will become apparent to those ordinarily skilled in the art upon reading the disclosure. The term “or” is used to refer to a nonexclusive “or” unless otherwise indicated.

Unless defined otherwise, all technical and scientific terms used herein have the same meaning as commonly understood to one of ordinary skill in the art. The following terms and phrases shall have the meaning indicated.

The term “about,” when referring to a number or a numerical value or range (including, for example, whole numbers, fractions, and percentages), means that the number or numerical range referred to is an approximation within experimental variability (or within statistical experimental error) and thus the numerical value or range can vary between 1% and 15% of the stated number or numerical range (e.g., +/−5% to 15% of the recited value, such as within 10%, within 5%, or within 1% of a stated value or stated limit of a range) provided that one of ordinary skill in the art would consider equivalent to the recited value (e.g., having the same function or result). The term “substantially” can allow for a degree of variability in a value or range, for example, within 90%, within 95%, 99%, 99.5%, 99.9%, 99.99%, or at least about 99.999% or more of a stated value or of a stated limit of a range.

In addition, it is to be understood that the phraseology or terminology employed herein, and not otherwise defined, is for the purpose of description only and not of limitation. Any use of section headings is intended to aid reading of the document and is not to be interpreted as limiting. Further, information that is relevant to a section heading may occur within or outside of that particular section.

What is claimed is:

1. A gluten-free, clean label, plant protein composition comprising the following ingredients: (a) a plant protein, (b) a vegetable oil, (c) corn zein, (d) rice starch, and (e) an aqueous, alkaline, divalent cation.

2. The composition of claim 1, wherein the plant protein is pea protein, chickpea protein, cranberry protein, navy bean protein, pinto bean protein, adzuki protein, fava protein, lima protein, black bean protein, lentil protein, red kidney bean protein, split pea protein, mung bean protein, Great Northern bean protein, black-eyed pea protein, Anasazi protein, cannellini protein, pumpkin seed protein, soy protein, rice protein, sorghum protein, millet protein, or a combination thereof.

3. The composition of claim 1, wherein the plant protein is present in an amount of about 50% w/w of dry ingredients.

4. The composition of claim 1, wherein the vegetable oil is olive oil.

5. The composition of claim 1, wherein the vegetable oil is present in an amount of about 5% v/w of dry ingredients.

6. The composition of claim 1, wherein corn zein is present in an amount of 25% w/w of dry ingredients.

7. The composition of claim 1, wherein rice starch is present in an amount of 25% w/w of dry ingredients.

8. The composition of claim 1, wherein the cation is calcium hydroxide (Ca(OH)₂).

9. The composition of claim 1, wherein the cation is present in an amount from about 1% to about 7% w/v of the aqueous solution used to mix with the dry ingredients.

10. The composition of claim 1, which comprises pea protein, olive oil, corn zein, rice starch, and Ca(OH)₂.

11. The composition of claim 10, which comprises pea protein in an amount of about 50% w/w of dry ingredients, olive oil in an amount of about 5% v/w of dry ingredients, corn zein in an amount of about 25% w/w of dry ingredients, rice starch in an amount of about 25% w/w of dry ingredients, and Ca(OH)₂ in an amount of about 1% to about 7% w/v of the aqueous solution used to mix with the dry ingredients.

12. A food product for human consumption comprising the composition of claim 1.

13. The food product of claim 12, which is a meat analogue.

14. The food product of claim 13, which comprises about 7% w/v Ca(OH)₂ solution.

15. The food product of claim 12, which is a hard cheese or canned fish analogue.

16. The food product of claim 15, which comprises about 5% w/v Ca(OH)₂ solution.

17. The food product of claim 12, which is a soft cheese or chicken analogue.

18. The food product of claim 17, which comprises about 3% w/v Ca(OH)₂ solution.

19. The food product of claim 12, which is a fish fillet analogue.

20. The food product of claim 19, which comprises about 1% w/v Ca(OH)₂ solution.

21. A food product for human consumption comprising the composition of claim 11.

22. The food product of claim 21, which is a meat analogue.

23. The food product of claim 22, which comprises about 7% w/v Ca(OH)₂ solution.

24. The food product of claim 21, which is a hard cheese or canned fish analogue.

25. The food product of claim 24, which comprises about 5% w/v Ca(OH)₂ solution.

26. The food product of claim 21, which is a soft cheese or chicken analogue.

27. The food product of claim 26, which comprises about 3% w/v Ca(OH)₂ solution.

28. The food product of claim 21, which is a fish fillet analogue.

29. The food product of claim 28, which comprises about 1% w/v Ca(OH)₂ solution.

30. A spreadable, gluten-free, clean label ingredient, plant protein composition comprising (a) a plant protein, (b) a vegetable oil, (c) corn zein, and (d) water.

31. The composition of claim 30, wherein the plant protein is pea protein, chickpea protein, cranberry protein, navy bean protein, pinto bean protein, adzuki protein, fava protein, lima protein, black bean protein, lentil protein, red kidney bean protein, split pea protein, mung bean protein, Great Northern bean protein, black-eyed pea protein, Anasazi protein, cannellini protein, pumpkin seed protein, soy protein, rice protein, sorghum protein, millet protein, or a combination thereof.

32. The composition of claim 30, wherein the plant protein is present in an amount of about 80% w/w of dry ingredients.

33. The composition of claim 30, wherein the vegetable oil is olive oil.

34. The composition of claim 30, wherein the vegetable oil is present in an amount of about 8% v/w of dry ingredients.

35. The composition of claim 30, wherein corn zein is present in an amount of about 20% w/w of dry ingredients.

36. The composition of claim 30, wherein water is present in an amount of about 120% to about 300% v/w of dry ingredients.

37. A food product for human consumption comprising the spreadable composition of claim 30.

38. The food product of claim 37, which is a nut butter analogue.

39. A method of making a gluten-free, clean label, plant protein composition, which method comprises:
i. mixing a plant protein with a vegetable oil;
ii. adding corn zein to the mixture;
iii. mixing;
iv. adding rice starch;
v. mixing;
vi. adding an aqueous, alkaline, divalent cation; and
vii. mixing,
whereupon a gluten-free, clean label, plant protein composition is made.

40. The method of claim 39, wherein the plant protein is pea protein, chickpea protein, cranberry protein, navy bean protein, pinto bean protein, adzuki protein, fava protein, lima protein, black bean protein, lentil protein, red kidney bean protein, split pea protein, mung bean protein, Great Northern bean protein, black-eyed pea protein, Anasazi protein, cannellini protein, pumpkin seed protein, soy protein, rice protein, sorghum protein, millet protein, or a combination thereof.

41. The method of claim 39, wherein the plant protein is present in an amount of about 50% w/w of dry ingredients.

42. The method of claim 39, wherein the vegetable oil is olive oil.

43. The method of claim 39, wherein the vegetable oil is present in an amount of about 5% v/w of dry ingredients.

44. The method of claim 39, wherein corn zein is present in an amount of 25% w/w of dry ingredients.

45. The method of claim 39, wherein rice starch is present in an amount of 25% w/w of dry ingredients.

46. The method of claim 39, wherein the cation is calcium hydroxide (Ca(OH)₂).

47. The method of claim 39, wherein the cation is present in an amount from about 1% to about 7% w/v of the aqueous solution.

48. A method of making a spreadable, gluten-free, clean label, plant protein composition, which method comprises:
i. mixing a plant protein with a vegetable oil;
ii. adding corn zein to the mixture;
iii. mixing;
iv. adding water; and
v. mixing,
whereupon a spreadable, gluten-free, clean label, plant protein composition is made.

49. The method of claim 48, wherein the plant protein is pea protein, chickpea protein, cranberry protein, navy bean protein, pinto bean protein, adzuki protein, fava protein, lima protein, black bean protein, lentil protein, red kidney bean protein, split pea protein, mung bean protein, Great Northern bean protein, black-eyed pea protein, Anasazi protein, cannellini protein, pumpkin seed protein, soy protein, rice protein, sorghum protein, millet protein, or a combination thereof.

50. The method of claim 48, wherein the plant protein is present in an amount of about 80% w/w of dry ingredients.

51. The method of claim 48, wherein the vegetable oil is olive oil.

52. The method of claim 48, wherein the vegetable oil is present in an amount of about 8% v/w of dry ingredients.

53. The method of claim 48, wherein corn zein is present in an amount of about 20% w/w of dry ingredients.

54. The method of claim 48, wherein water is present in an amount of about 120% to about 300% v/w.
